(19) United States
(12) Patent Application Publication
(10) Pub. No.: US 2022/0108361 A1
(43) Pub. Date: Apr. 7, 2022

(54) ROOFING ESTIMATE SYSTEM

(71) Applicant: Peak Innovations Inc., Richmond (CA)

(72) Inventor: Simon Walker, Delta (CA)

(21) Appl. No.: 17/423,211

(22) PCT Filed: Jan. 21, 2020
(86) PCT No.: PCT/CA2020/050065

§ 371 Date: Jul. 15, 2021

Related U.S. Application Data
(60) Provisional application No. 62/794,799, filed on Jan. 21, 2019.

(51) Int. Cl. G06Q 30/02; G06Q 30/06; G06Q 50/08; G06V 20/10; G06V 20/13; H04W 4/35

(52) U.S. Cl. CPC G06Q 30/0283; G06Q 30/0637; H04W 4/35; G06V 20/176; G06V 20/13; G06Q 50/08

(57) ABSTRACT

A system for estimating a cost for replacing a roof comprises a server, a database, and one or more devices. Each of the devices comprises a user interface and is configured to accept input regarding an address at which the roof thereof is to be replaced. The server is configured to communicate with a satellite image provider regarding the address and to accept from the satellite image provider one or more satellite images of the roof at the address. The server is further configured to accept from the satellite image provider roof information regarding the roof and to generate an estimate for the cost of replacing the roof. The estimate is dependent, at least in part, on the roof information, materials cost, waste cost, and labour cost. The server is further configured to communicate the estimate to the device for display on the user interface.

### FIELD OF THE INVENTION

The invention relates to a system for generating an estimate for roofing work for a residential building.

### BACKGROUND OF THE INVENTION

The roofs of residential buildings have to be periodically replaced, and the costs associated with such replacements may be significant. Typically, a homeowner who is in need of a roof replacement will contact a contractor for an estimate. The contractor will visit the residential building in order to assess the current roof and to obtain the approximate dimensions of the roof. Based on this information, the contractor is able to prepare an estimate of the cost for replacing the roof. The homeowner can then decide whether to proceed with the work.

However, this process is both time-consuming and cumbersome. It requires that the contractor travel to the location of the residential building. It also requires that the contractor obtain accurate dimensions of the roof. Otherwise, the estimate prepared by the contractor may be unreliable.

Therefore, it is desirable for a system for generating an estimate for roofing work that is both timely and accurate.

### SUMMARY OF THE INVENTION

A system for generating a cost estimate for roofing work comprises a host application and a user interface. A remote user interested in obtaining a cost estimate initiates the host application and provides an address for a residential building to the host application. The host application contacts a satellite image provider to determine whether the satellite image provider has images and data relating to the residential building. If it does, the host application is able to generate a cost estimate based on data received from the satellite image provider. The data may include information on the various facets of the roof, including dimensions and slopes.

In accordance with one embodiment of the invention, a system for estimating a cost for replacing a roof comprises a server, a database, and one or more devices. The database is connected to the server and comprises price information. The one or more devices are in wireless communication with the server. Each of the devices comprises a user interface and is configured to accept, through the user interface, input regarding an address at which the roof thereof is to be replaced. The server, in response to the input regarding the address, is configured to communicate with a satellite image provider regarding the address and to accept from the satellite image provider one or more satellite images of the roof at the address. The server, in response to the one or more satellite images, is further configured to transmit at least one of the one or more satellite images of the roof to the device for display on the user interface. The device is further configured to accept, through the user interface, confirmation that the at least one of the one or more satellite images correspond to the roof at the address. The server, in response to the confirmation, is further configured to accept from the satellite image provider roof information regarding the roof and to generate an estimate for the cost of replacing the roof. The estimate is dependent, at least in part, on the roof information, materials cost, waste cost, and labour cost, the materials cost being based, at least in part, on the price information. The server is further configured to communicate the estimate to the device for display on the user interface.

According to another embodiment, the roof information comprises at least one or more of the following: a number of facets for the roof, an area of the roof, dimensions of hips for the roof, dimensions of ridges for the roof, dimensions of valleys for the roof, dimensions of rakes for the roof, dimensions of eaves for the roof, dimensions of drip edges for the roof, and an approximate height of the roof.

According to still another embodiment, the waste cost is based, at least in part, on the area of the roof and the number of facets.

According to a further embodiment, the materials cost is also based, at least in part, on the roof information.

According to still a further embodiment, the device is further configured to accept, through the user interface, a type of materials for the roof, wherein the server is further configured to accept from the device the type of materials for the roof, and wherein the materials cost is also based, at least in part, on the type of materials for the roof.

The foregoing was intended as a summary only and of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The embodiments of the invention will be described by reference to the drawings thereof, in which:

FIG. 1 shows an overview of the system in accordance with an embodiment of the invention;

FIG. 2 shows a sample image of a roof;

FIG. 3 shows a flowchart depicting the general process flow for the system of FIG. 1; and

FIG. 4 shows a flowchart depicting the general process flow for determining the cost estimate.

### DETAILED DESCRIPTION OF THE INVENTION

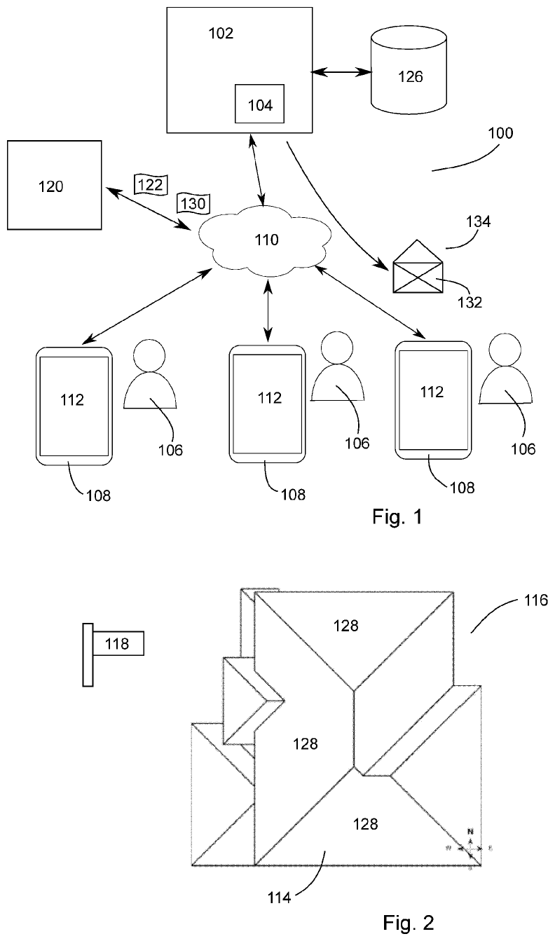

Referring to FIG. 1, a system 100 for generating an estimate for roofing work comprises a host server 102 that supports a host application 104 accessible by one or more remote users 106. The remote users 106 are able to access the host application 104 using communication devices 108 over a communications network 110 (e.g. the Internet). The communications devices 108 may include computers, tablets, smartphones, or other computing devices. Each of the communications devices 108 is configured to display a user interface 112 that allows for interfacing and interacting with the host application 104 over the communications network 110. The user interface 112 is preferably a graphical user interface and may include a virtual keyboard to allow the inputting of text data.

Through the user interface 112, the remote users 106 are able to access the host application 104. For example, where the communications network 110 is the Internet, the host application 104 may be a web-based application that may be accessed using a browser program on the communication devices 108 and viewed using the user interface 112.

If the remote user 106 wishes to obtain an estimate for the cost of replacing a roof 114 (e.g. FIG. 2) of a residential building 116, the remote user 106 accesses the host application 104 using the communication device 108 over the communications network 110.

When the remote user 106 first initiates the host application 104, the remote user 106 is prompted by the user interface 112 to enter an address 118 for the residential building 116. Upon receiving the address 118, the host application 104 will communicate with a satellite image provider 120 to request information from the satellite image provider 120 regarding the residential building 116 at the address 118. The communications between the host application 104 and the satellite image provider 120 may be done over the communications network 110 (e.g. the Internet). For example, one such satellite image provider 120 may be Eagle View Technologies, Inc.

If the satellite image provider 120 has data regarding the residential building 116 at the address 118, the satellite image provider 120 will transmit to the host application 104 one or more satellite images 122 of the residential building 116 at the address 118. The satellite images 122 may include one or more of the following views: an overhead view, a view from the north side, a view from the south side, a view from the east side, and a view from the west side. Preferably, at least one of the satellite images 122 will depict the roof 114. The host application 104 will then display at least one of the satellite images 122 through the user interface 112. The user interface 112 will prompt the remote user 106 to confirm that the satellite images 122 depict the residential building 116 for which the remote user 106 is interested in having the roof 114 replaced.

If the satellite image provider 120 does not have data regarding the residential building 116 at the address 118 provided by the remote user 106, the satellite image provider 120 will communicate this to the host application 104, which in turn will generate a message to the remote user 106 through the user interface 112. The user interface 112 may then prompt the remote user 106 to provide identification information (e.g. the name and contact information for the remote user 106) so that someone can follow up with the remote user 106.

Also, if the remote user 106 responds through the user interface 112 that the satellite images 122 do not depict the residential building 116 in which the remote user 106 is interested in having the roof 114 replaced, the user interface 112 may also prompt the remote user 106 to provide identification information so that someone can follow up with the remote user 106.

If the remote user 106 responds through the user interface 112 that the satellite images 122 do depict the residential building 116 for which the remote user 106 is interested in having the roof 114 replaced, the user interface 112 will still prompt the remote user 106 to provide identification information. The user interface 112 may also prompt the remote user 106 to confirm that the remote user 106 wishes to receive an estimate for the cost of replacing the roof 114.

The identification information is preferably stored by the host application 102 in a database 126 on the host server 102.

If the remote user 106 confirms that the remote user 106 wishes to receive an estimate for the cost of replacing the roof 114, the host application 104 will display a message through the user interface 112 advising the remote user 106 that an estimate will be generated.

The host application 104 communicates with the satellite image provider 120 to request additional data regarding the residential building 116, and in particular, regarding the roof 114. The satellite image provider 120 communicates the requested data to the host application 104, which preferably includes one or more of the following:
(a) Number of facets 128 (or roof sections) of the roof 114;
(b) Area of the roof 114 (total and broken down based on a pitch of the various facets 128);
(c) Dimensions of any hips for the roof 114;
(d) Dimensions of any ridges for the roof 114;
(e) Dimensions of any valleys for the roof 114;
(f) Dimensions of any rakes (i.e. roof edges that are sloped) for the roof 114;
(g) Dimensions of any eaves (i.e. roof edges that are level) for the roof 114;
(h) Dimensions of any drip edges for the roof 114;
(i) Approximate height of the roof 114; and
(j) One or more additional images 130 for the roof 114.

If the data received from the satellite image provider 120 indicates that the roof 114 is flat, then the host application 104 generates an error message that is displayed to the remote user 106 through the user interface 112. This is because in one embodiment of the invention, the system 100 is not able to accommodate flat roofs.

Based on the data received from the satellite image provider 120, the host application 104 is able to generate a cost estimate 132 for replacing the roof 114.

The cost estimate 132 is generated based on a number of factors, including the cost of the anticipated waste, the anticipated cost of materials, the anticipated cost of labour, and other miscellaneous costs. Based on these factors (as described below), the host application 104 is preferably able to generate a single dollar amount for the cost estimate 132 that is presented to the remote user 106. Based on that, the remote user 106 is then given the option to proceed with the work by selecting the appropriate response through the user interface 112.

The cost of the anticipated waste is dependent on a number of factors, such as the area of the roof 114 and the number of facets 128. The cost of the anticipated waste may be calculated as a percentage of the area of the roof 114. Additionally, if the number of facets 128 is high, the percentage may be higher. By way of example only, if the number of facets 128 is 15 or less, then the percentage used may be 10%. If the number of facets 128 is between 16 and 24, then the percentage used may be 12%. Finally, if the number of facets 128 is greater than or equal to 25, then the percentage used may be 15%. Other factors may also affect the cost of the anticipated waste (e.g. the presence of hips, etc.).

The anticipated cost of materials is mainly dependent on the area of the roof 114 and the material to be used for the roof 114 (e.g. the type of shingles). The type of materials to be used may be specified by the remote user 106 through the user interface 112. Additionally, shingles are typically sold in bundles, with different types of shingles being sold in different number of bundles/square (a square being 100 square feet).

Another factor in the anticipated cost of materials is the amount of capping, which is the sum of the lengths of the ridges and hips (plus a waste factor). Capping is typically also sold in bundles, with each bundle covering a particular length of capping.

Another factor in the anticipated cost of materials is the amount of starters, which is the length of the drip edges. Starters are typically also sold in bundles, with each bundle covering a particular length of starters.

The anticipated cost of materials may also include an amount for product warranties. Typically, the cost for product warranties is dependent on the amount of squares purchased.

The anticipated cost of materials may also include the cost for vents. The number of vents in the roof 114 may not be available from the satellite image provider 120. If that is the case, an approximation must be made. For example, one possible approximation may be based on the area of the roof 114, with one vent provided for every 300 square feet of roof 114. Other vents (e.g. bathroom vents, gooseneck vents, etc.) may also be taken into account.

The number of such other vents required may be approximated based on comparing with similarly-sized roofs 114 accessible by the host application 104.

Other materials that may also be taken into account include the following: roof decks, weather membranes, underlayments, zinc strips, flashing, and metal rake edges. Some of these materials are sold in fixed amounts per unit; therefore, it may be necessary to determine the minimum number of units required for these materials.

Preferably, the prices for the various materials typically required in replacing the roof 114 (e.g. shingles, capping, vents, etc.) are stored in the database 126 and may be retrieved by the host server 102 when determining the anticipated cost of materials.

The anticipated cost of labour may be divided into the costs for individual steps. For example, the anticipated cost of labour may be divided into the cost for applying shingles, the cost for tearing off existing shingles, the cost of disposal, and the cost for deck replacement, if necessary. Furthermore, some of these steps may be further subdivided. For example, the cost for applying shingles may be further divided into the cost for applying the shingles, the cost for applying the capping, and the cost for applying the starters.

The cost for tearing off existing shingles will depend, in part, on the type of shingles involved and whether there are any additional layers. For example, it is typically more expensive to tear off concrete or clay tiles compared to asphalt shingles. This information may not be available from the satellite image provider 120 and may require additional input from the remote user 106. Alternatively, the possibility of having to accommodate different types of shingles may need to be built into the cost estimate 132.

The cost for disposal will also depend, in part, on the type of shingles involved. For example, it is typically more expensive to dispose of concrete or clay tiles compared to asphalt shingles. This information may not be available from the satellite image provider 120 and may require additional input from the remote user 106. Alternatively, the possibility of having to accommodate different types of shingles may need to be built into the cost estimate 132.

The cost for deck replacement, if necessary, would typically not be assessable until after the roof 114 has been removed. In one embodiment, the cost for deck replacement would not be included in the cost estimate 132.

There may be additional labour costs as well. This could include the cost for installing weather membrane, installing drip/rake edges, installing vents, installing zinc strips, and chimney work. These costs may be dependent on the dimensions or number of the materials involved.

Depending on the circumstances, there may be further costs to be included in the cost estimate 132. These may include factors like delivery costs (which may depend on the location of the residential building 116) and pictometry costs.

The cost estimate 132 may be presented to the remote user 106 on the user interface 112. In addition, the cost estimate 132 may also be included in a report 134 generated by the host application 104. The report 134 may include one or more of the additional images 130 or one or more of the satellite images 122. The report 134 may be sent by electronic mail to the remote user 106.

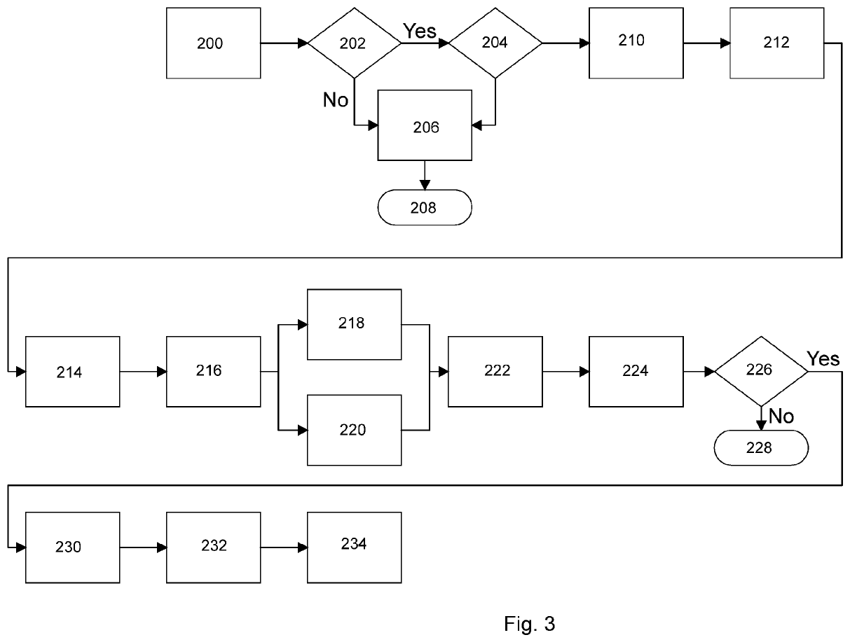

FIG. 3 depicts a flow chart for the general process flow for the system 100. At step 200, the remote user 106 inputs the address 118 using the user interface 112. At step 202, the host application 104 contacts the satellite image provider 120 to determine whether the satellite image provider 120 has data regarding the residential building 116 at the address 118. If it does not, the host application 104 proceeds to step 206, where the host application 104 prompts the remote user 106 to provide identification information for later follow-up. The host application 104 then proceeds to step 208 and ends.

If the satellite image provider 120 has data regarding the residential building 116 at the address 118, the host application 104 proceeds to step 204 and prompts the remote user 106 to confirm whether the satellite images 122 received from the satellite image provider 120 correspond to the residential building 116 specified by the remote user 106. If they do not, the host application 104 proceeds to step 206, where the host application 104 prompts the remote user 106 to provide identification information for later follow-up. The host application 104 then proceeds to step 208 and ends.

If the satellite images 122 correspond to the residential building 116 specified by the remote user 106, the host application 104 advises the remote user 106 (at step 210) that a cost estimate 132 will be generated. The host application 104 then receives the additional data from the satellite image provider 120 regarding the residential building 116 (at step 212).

From this additional data, the host application 104 is able to generate the cost estimate 132 (at step 214). At step 216, the host application 104 sends the report 134 containing the cost estimate 132 to the remote user 106, such as through electronic mail.

At that point, the remote user 106 may initiate contact with the contractor (at step 218) or alternatively, the contractor may contact the remote user 106 (at step 220). In either case, an appointment may be booked with the remote user 106 (at step 222). The appointment may be for a phone or online meeting (at step 224). During that time, the remote user 106 may decide whether to proceed with the work (at step 226). The remote user 106 may decide not to proceed with the work (at step 228).

If the remote user 106 decides to proceed with the work, a contract may be finalized (at step 230) and approved (at step 232). The work is then placed into the general workflow pipeline (at step 234).

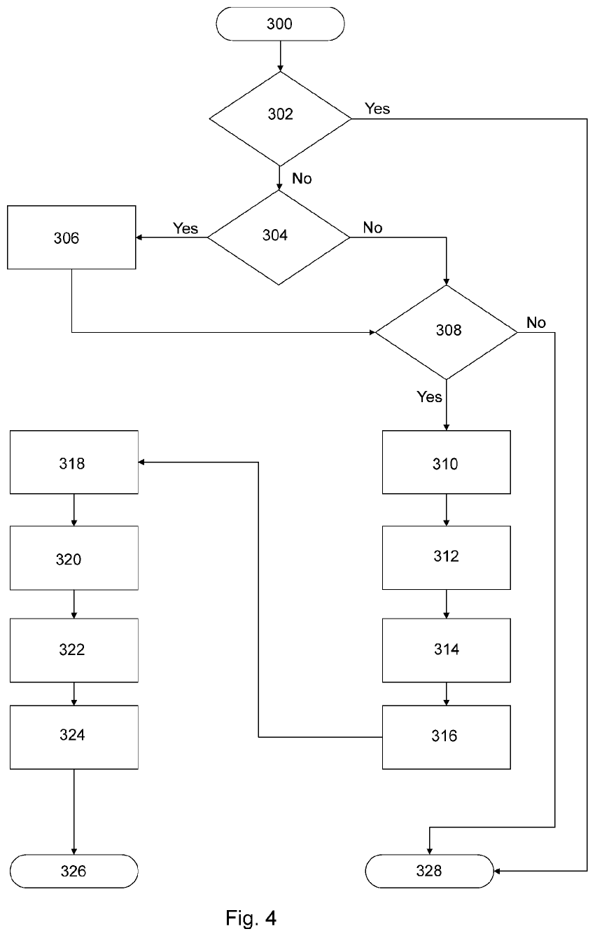

FIG. 4 depicts a flow chart for the general process flow for determining the cost estimate 132. At step 300, the additional data from the satellite image provider 120 is received by the host application 104. The host application 104 (at step 302) determines whether the main structure of the roof 114 is flat. If it is, the host application 104 proceeds to step 328, where the host application 104 advises the remote user 106 that the cost estimate 132 cannot be generated.

If the main structure of the roof 114 is determined not to be flat, the host application 104 determines whether the roof 114 contains multiple structures (at step 304). If the roof 114 contains multiple structures, the host application 104 determines whether any of these structures are flat (at step 306). If so, the structures that are flat are marked so that they are appropriately dealt with later on by the host application 104.

The host application 104 determines (at step 308) whether the general area where the residential building 116 is located is in an area that the contactor can service. If it is not in an area that the contractor can service, the host application 104 advises the remote user 106 accordingly (at step 328) and ends.

Otherwise, the host application 104 retrieves (at step 310) a bill of materials and labour for the area where the residential building 116 is located. This information may be stored in the database 126. The host application 104 is able to determine an item list for the roofing work (at step 312). Based on the data from the satellite image provider 120, the host application 104 is able set the area properties for items that are based on square footage units (at step 314). Similarly, the host application 104 is able to set the linear properties for items that are based on linear units (at step 316).

The host application 104 is then able (at step 318) to provide an estimate of the quantities and costs for the items required for the roofing work. The host application 104 (at step 320) determines the items that will be shown in the report 134. The host application 104 also sets the appropriate disclaimers and flags (at step 322). Based on this, the overall cost estimate 132 is generated (at step 324), which may be then presented to the remote user 106 (at step 326).

It will be appreciated by those skilled in the art that the preferred embodiment has been described in some detail but that certain modifications may be practiced without departing from the principles of the invention.

1. A system for estimating a cost for replacing a roof, the system comprising:
a server;
a database connected to the server, the database comprising price information;
one or more devices in wireless communication with the server, wherein each of the devices comprises a user interface;
wherein each of the one or more devices is configured to accept, through the user interface, input regarding an address at which the roof thereof is to be replaced;
wherein the server, in response to the input regarding the address, is configured to communicate with a satellite image provider regarding the address and to accept from the satellite image provider one or more satellite images of the roof at the address;
wherein the server, in response to the one or more satellite images, is further configured to transmit at least one of the one or more satellite images of the roof to the device for display on the user interface;
wherein the device is further configured to accept, through the user interface, confirmation that the at least one of the one or more satellite images correspond to the roof at the address;
wherein the server, in response to the confirmation, is further configured to accept from the satellite image provider roof information regarding the roof and to generate an estimate for the cost of replacing the roof, the estimate being dependent, at least in part, on the roof information, materials cost, waste cost, and labour cost, the materials cost being based, at least in part, on the price information; and
wherein the server is further configured to communicate the estimate to the device for display on the user interface.

2. The system of claim 1, wherein the roof information comprises at least one or more of the following: a number of facets for the roof, an area of the roof, dimensions of hips for the roof, dimensions of ridges for the roof, dimensions of valleys for the roof, dimensions of rakes for the roof, dimensions of eaves for the roof, dimensions of drip edges for the roof, and an approximate height of the roof.

3. The system of claim 2, wherein the waste cost is based, at least in part, on the area of the roof and the number of facets.

4. The system of claim 2, wherein the materials cost is also based, at least in part, on the roof information.

5. The system of claim 1, wherein the device is further configured to accept, through the user interface, a type of materials for the roof, wherein the server is further configured to accept from the device the type of materials for the roof, and wherein the materials cost is also based, at least in part, on the type of materials for the roof.
